(19) United States
(12) Patent Application Publication
(10) Pub. No.: US 2004/0204512 A1
(43) Pub. Date: Oct. 14, 2004

(54) Foams and methods of producing foams

(76) Inventors: Mary Bogdan, Buffalo, NY (US); Leslie Bement, Buffalo, NY (US); David Williams, East Amherst, NY (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/491,646

(22) PCT Filed: Oct. 1, 2002
(86) PCT No.: PCT/US02/31302

(30) Foreign Application Priority Data
Oct. 1, 2001 (US) 60326469

(51) Int. Cl. C08J 9/00; C08G 18/00

(52) U.S. Cl. 521/99; 521/155

(57) ABSTRACT

Disclosed are low k-factor foams and methods of producing such foams. The methods comprise cooling high boiling blowing agent compounds to low temperatures and in introducing such cooled, high boiling blowing agents to the reaction mixture from which the foam is made.

### CROSS REFERENCE TO PROVISIONAL APPLICATION

The present application is related to and claims the priority benefit of U.S. Provisional Application No. 60/326,469, filed Oct. 1, 2001.

### FIELD OF INVENTION

The present invention relates to methods for producing foams, including polyurethane and/or polyisocyanurate closed-cell foams. More specifically, the present invention relates to a method of producing foams using a blowing agent that contains a relatively high boiling point compound, such as 1,1,1,3,3-pentafluorobutane (“HFC-365mfc”).

### BACKGROUND

Low-density rigid foams, such as polyurethane and polyisocyanurate foams, are used in a wide variety of applications including insulation for roofing systems, building panels, refrigerators and freezers. To be useful in such applications, it is critical for the foams to exhibit, among other properties, relatively high thermal insulation. One measure of a foam's thermal insulation properties is its “k-factor”. The term “k-factor” refers generally to the rate of transfer of heat energy by conduction through one square foot of one inch thick homogenous material in one hour where there is a difference of one degree Fahrenheit perpendicularly across the two surfaces of the material. Since the utility of closed-cell foams is based, at least in part, upon their thermal insulation properties, it is advantageous and desirable to produce rigid foams having low k-factors.

Known methods for producing rigid foams generally comprise reacting an organic polyisocyanurate and a polyol in the presence of a blowing agent to form a rigid foam. See, for example, Saunders and Frisch, Volumes I and II Polyurethanes Chemistry and Technology (1962), which is incorporated herein by reference. While the thermal properties of foams produced by these conventional methods may be adequate for selected applications, there is a constant need in the art to identify methods for producing foams having k-factors at least as low or lower than those produced via conventional methods.

### DESCRIPTION OF THE INVENTION

One aspect of the present invention meets the aforementioned need, and other needs, by providing a method for producing foams having low k-factors. Applicants have discovered that methods for producing foams advantageously include providing to a foamable reaction mixture a blowing agent which comprises a fluorocarbon compound having a relatively high boiling point, such as HFC-365, at a relatively low temperature, and in certain embodiments at a temperature below the initial reaction temperature of the reaction mixture. Such methods, in preferred embodiments, produce rigid foams having desirably low k-factors. In preferred embodiments, the fluorocarbon compound having a relatively high boiling point is a hydrofluorocarbon having from about 4 to about 6 carbon atoms.

As used herein, the term “initial reaction temperature” refers generally to the average temperature of a reaction mixture upon initiation of the reaction. For example, where two reaction components A and B, each at a temperature of 70° F., are combined to form a reaction mixture and initiate a reaction, the initial reaction temperature for that mixture will be about 70° F., even if the temperature of reaction rapidly and/or radically increases or decreases after the components are initially combined.

As used herein, the term “foamable” reaction mixture refers to one or more compounds which, in the presence of a blowing agent, are capable of reacting to form a rigid foam.

As used herein, the term “high boiling” refers to compounds that have a boiling point of not less than about 77° F. In preferred embodiments, the high boiling compound of the present invention have a a boiling point of not less than about 85° F., more preferably not less than about 95° F., and even more preferably of not less than about 100° F.

One aspect of the present invention is a method for producing closed-cell foams by providing to a foamable reaction mixture a blowing agent which is at a temperature below the initial reaction temperature of the reaction mixture. In certain preferred embodiments, the method comprises:

(a) providing a foamable reaction mixture; and

(b) introducing to the reaction mixture, or one or more components of the reaction mixture, a blowing agent at a temperature that is less than the initial reaction temperature of the reaction mixture. Another aspect of the present invention is a closed-cell foam produced according to the methods of the present invention. Another aspect of the invention is the discovery that blowing agents comprising HFC-365 are particularly useful in producing low k-factor foams in accordance with the present invention.

Applicants have discovered that providing relatively high-boiling fluorocarbon-based blowing agents, such those which comprise HFC-365, and particularly HFC-365mfc, to a reaction mixture wherein the temperature of the provided blowing agent is less than, and preferably substantially less than, the initial reaction temperature of the reaction mixture, can result in the formation of foams having k-factors that are at least as low as, and often lower than, foams produced via conventional methods. In other embodiments of the present invention, low k-factor foams can be produced by methods which comprise providing to a reaction mixture a blowing agent at a temperature that is less than about 76° F., more preferably less than about 70° F., and even more preferably less than about 60° F., without regard to the initial reaction temperature of the reaction mixture.

Conventional methods for producing foams using high boiling point blowing agents involve maintaining the blowing agent at or above the initial reaction temperature, and generally at or above room temperature, both prior to, and throughout, the foam-producing reaction. Because HFC-365mfc has a relatively high boiling point (104° F. (40° C.)), it is stable at relatively high temperatures and can thus be easily handled and maintained at temperatures normally used for high boiling point blowing agents. Conventional methods have heretofore been used at these high temperatures for several reasons. One reason is that extra cost is associated with cooling such blowing agents, and heretofore those skilled in the art have not perceived or expected that benefit could be gained as a result of incurring such additional operating cost. In addition, the cooling of blowing agents to a temperature less than the initial reaction temperature generally requires the addition of extra catalyst and heat energy to the reaction mixture, in order to produce the rigid foam, which further increases the costs associated with foam production. Accordingly, there is no motivation in the prior art to provide to reaction mixtures such blowing agents at temperatures either below about room temperature (approximately 72° F.) and/or below the initial reaction temperature.

By providing high boiling blowing agents, particularly and preferably those comprising HIFC-365, to foamable reaction mixtures at temperatures below about room temperature and/or the initial reaction temperature, applicants have surprising discovered that foams having relatively low k-factors, as compared to foams made by conventional mechanisms, can be produced. For example, by providing a blowing agent comprising HFC-365mfc at about 50° F. (10° C.) or less to a reaction mixture having an initial reaction temperature of between about 55-70° F., applicants have produced a foam with significantly lower k-factor than is produced via providing the same blowing agent at about 70° F. (21.1° C.) to a reaction mixture having an initial reaction temperature of about 70° F. Such results are highly desirable as well as unexpected.

According to certain embodiments, the present invention relates to a method for producing a foam comprising the steps of providing a reaction mixture capable of forming a foam, preferably a rigid foam, and providing to the reaction mixture a blowing agent at a temperature below the initial reaction temperature of the reaction mixture.

Any of a wide range of reaction mixtures capable of forming foams and known methods for producing such reaction mixtures can be adapted for use in accordance with the present invention, including those described, for example, in Saunders and Frisch, Volumes I and II Polyurethanes Chemistry and Technology (1962), incorporated herein by reference. In general, such methods comprise combining an isocyanate, a polyol or mixture of polyols, a blowing agent (including blends or mixtures of compounds which together act as the blowing agent), and other materials such as catalysts, surfactants, and optionally, flame retardants, colorants, or other additives either separately or in mixtures of two or more thereof (i.e. as pre-blended foam formulations) to form a reaction mixture capable of creating a foam, preferably a rigid foam.

Many particular techniques can be used within the scope of the present invention to provide to the reaction mixture a blowing agent at temperatures below about room temperature and/or at temperatures below the initial reaction temperature. For example, the blowing agent may be stored at a temperature at or above the initial reaction temperature and then cooled just prior to adding the blowing agent to the reaction mixture or to one or more of the components that will be combined with other components to form the reaction mixture. Alternatively, the blowing agent may be stored at a temperature below the initial reaction temperature of the reaction mixture and subsequently added to the reaction mixture or to one or more components that will be combined with other components to form the reaction mixture.

Furthermore, as indicated above, the blowing agent may be combined with other components of the reaction mixture to form a premix prior to being introduced to the reaction mixture. According to these embodiments, the blowing agent may be cooled to a temperature below the initial reaction temperature either before or after being combined with other components of a premix. For example, the blowing agent may be stored at a temperature below the initial reaction temperature and added to the premix prior to providing the blowing agent to the reaction mixture. For such methods in which the blowing agent is added to one or more components that will be subsequently combined with other components to form the reaction mixture, it will be generally be required that the premix which contains the blowing agent be processed under conditions effective to ensure that the temperature of the blowing agent is as indicated herein at the time it is introduced to or otherwise provided to the completed reaction mixture. For example, in some embodiments it may be required to further cool the premix containing the blowing agent prior to mixing same with the remaining components of the reaction mixture. Alternatively, the blowing agent at or above the initial reaction temperature may be added to the premix and subsequently cooled to a temperature below the initial reaction temperature prior to providing the cooled premix, containing the blowing agent, to the reaction mixture.

The blowing agents and premix compositions containing the blowing agents of the present invention can be cooled to or stored at the required temperature, including temperatures below room temperature, using any of a wide range of known heat-transfer or refrigeration equipment.

According to certain preferred embodiments, the blowing agent is provided at a temperature of at least about 3° F. below the initial reaction temperature. Preferably, the high boiling blowing agent is at least about 5° F. below the initial reaction temperature, more preferably at least about 10° F. below the initial reaction temperature, and even more preferably at least about 13° F. below the initial reaction temperature.

According to certain embodiments, the blowing agent of the present invention is provided to the reaction mixture at a temperature below about 65° F. In certain preferred embodiments the blowing agent of the present invention is provided to the reaction mixture at a temperature below about 60° F. In certain other preferred embodiments, the blowing agent of the present invention is provided to the reaction mixture at a temperature below about 55° F., and in other preferred embodiments at a temperature of below about 50° F.

It is convenient in many applications to provide the components for polyurethane or polyisocyanurate foams in pre-blended foam formulations. Most typically, the foam formulation is pre-blended into two components. The isocyanate or polyisocyanate composition comprises the first component, commonly referred to as the “A” component. The polyol or polyol mixture, surfactant, catalysts, blowing agents, flame retardant, and other isocyanate reactive components comprise the second component, commonly referred to as the “B” component. While the surfactant, catalyst(s) and blowing agent are usually included with the polyol component, they may included with the “A” component, or partly in the A component and partly in the B component. Accordingly, polyurethane or polyisocyanurate foams are readily prepared by bringing together the A and B components either by hand mix, for small preparations, or preferably machine mix techniques to form blocks, slabs, laminates, pour-in-place panels and other items, spray applied foams, froths, and the like. Optionally, other ingredients such as fire retardant, colorants, auxiliary blowing agents, water, and even other polyols can be added as a third stream to the mix head or reaction site. Most conveniently, however, they are all incorporated into one B component.

Any organic polyisocyanate can be employed in polyurethane or polyisocyanurate foam synthesis inclusive of aliphatic and aromatic polyisocyanates. Preferred, as a class is the aromatic polyisocyanates. Preferred polyisocyanates for rigid polyurethane or polyisocyanurate foam synthesis are the polymethylene polyphenyl isocyanates, particularly the mixtures containing from about 30 to about 85 percent by weight of methylenebis(phenyl isocyanate) with the remainder of the mixture comprising the polymethylene polyphenyl polyisocyanates of functionality higher than 2. Preferred polyisocyanates for flexible polyurethane foam synthesis are toluene diisocyanates including, without limitation, 2,4-toluene diisocyanate, 2,6-toluene diisocyanate, and mixtures of two or more thereof.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Typical polyols used in the manufacture of flexible polyurethane foams include, but are not limited to, those based on glycerol, ethylene glycol, trimethylolpropane, ethylene diamine, pentaerythritol, and the like condensed with ethylene oxide, propylene oxide, butylene oxide, and the like. These are generally referred to as “polyether polyols”. Another example is the graft copolymer polyols, which include, but are not limited to, conventional polyether polyols with vinyl polymer grafted to the polyether polyol chain. Yet another example is polyurea modified polyols which consist of conventional polyether polyols with polyurea particles dispersed in the polyol.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose-based polyols, and used in polyurethane foam applications.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts are used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic acid salts, and mixtures thereof. Preferred species within the classes are potassium acetate, potassium octoate, and N-(2-hydroxy-5-nonylphenol)methyl-N-methylglycinate.

Any of a wide range of blowing agents can be used in accordance with the general teachings contained herein. For example, the blowing agent may consist essentially of HFC-365mfc, or may comprise non-azeotropic, azeotropic, and/or azeotrope-like blends of HFC-365 with other blowing agent compounds. Examples of suitable other blowing agent compounds include: fluorocarbons, such as, for example, trichlorofluoromethane, dichlorodifluoromethane, chlorotrifluoromethane, tetrafluoromethane, dichlorofluoromethane, chlorodifluoromethane, trifluoromethane, dichloromethane, chlorofluoromethane, difluoromethane, chloromethane, fluoromethane, 1,1,2-trichloro-1,2,2-trifluoromethane, 1,2-dichloro-1,1,2,2-tetrafluoromethane, chloropentafluoroethane, hexafluoroethane, 2,2-dichloro-1,1,1,-trifluoroethane, 1-chloro-1,1,1,2-tetrafluoroethane, pentafluorethane, 1,1,1,2-tetrafluoroethane, 1,1-dichloro-1-fluoroethane, 1,chloro-1,1-difluoroethane, 1,1,1-trifluoroethane, octafluoropropane, 1,1,1,2,3,3,3-heptafluoropropane, 1,1,1,3,3,3-hexafluoropropane, 1,1,1,3,3-pentafluoropropane, 1,1,1,3,3-pentafluorobutane, and octafluorocyclobutane; hydrocarbons, such as, for example, methane, ethane, propane, isopropane, n-butane, isobutane, tert-butane, n-pentane, isopentane, cyclopentane, n-hexane, isohexane, cyclohexane; as well as combinations of two or more of any of the aforementioned blowing agents. Preferably, the blowing agent for use in the present methods comprises a high-boiling composition. As used herein, the term “high-boiling” refers generally to any blowing agent having a boiling point of above about 25° C.

It is contemplated within the broad scope of the present invention that the blowing agent may comprise a wide range of relative concentrations of high boiling blowing agent. For example, it is contemplated that in ceratin embodiments the blowing agent will comprise at least about 50% by weight and up to about 100% by weight of high boiling components, which high boiling components preferably comprise and even more preferably consist essentially of HFC-365mfc. In other embodiments, it is contemplated that the blowing agent will comprise as low as about 1% by weight and up to about 50% by weight of high boiling components, which high boiling components preferably comprise and even more preferably consist essentially of HFC-365mfc. In such embodiments, the balance of the blowing agent can comprise low boiling blowing agents as well as one or more of any well known blowing agent additives, including those mentioned below.

In certain preferred embodiments the blowing agent of the present invention comprises, and even more preferably consists essentially of, a combination of pentafluropropane, preferably 1,1,1,3,3-pentafluoropropane (HFC-245fa), and pentafluorobutante, preferably 1,1,1,3,3-pentafluorobutane (HFC-365mfc). Although it is contemplated that these components can be combined in a wide variety of relative weight ratios, the following table identifies several preferred weight ratio combinations, it being understood that the percentages are understood to be prefaced by “about.”

| Wt % pentafluoropropane | Wt % pentafluorobutane |
|---|---|
| range | range |
| 51-99 | 1-49 |
| 60-99 | 1-40 |
| 70-99 | 1-30 |
| 80-99 | 1-20 |
| 90-99 | 1-10 |

Dispersing agents, cell stabilizers, and surfactants may be incorporated into the blowing agent mixture. Surfactants, better known as silicone oils, may be added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which is incorporated herein by reference.

Other optional additives for the blowing agent mixture may include flame retardants such as tris(2-chloroethyl) phosphate, tris (2-chloropropyl) phosphate, tris (2,3-dibromopropyl) phosphate, tris (1,3-dichloropropyl) phosphate, diammonium phosphate, various halogenated aromatic compounds, antimony oxide, aluminum trihydrate, polyvinyl chloride, and the like. Other optional ingredients may include from 0 to about 3 percent water, which chemically reacts with the isocyanate to produce carbon dioxide. The carbon dioxide acts as an auxiliary-blowing agent.

In general, the amount of blowing agent present in the blended mixture is dictated by the desired foam densities of the final polyurethane or polyisocyanurate foams products. The polyurethane foams produced can vary in density from about 0.5 pound per cubic foot to about 40 pounds per cubic foot, preferably from about 1.0 to about 20.0 pounds per cubic foot, and most preferably from about 1.5 to about 6.0 pounds per cubic foot for rigid polyurethane foams and from about 1.0 to about 4.0 pounds per cubic foot for flexible foams. The density obtained is a function of how much of the blowing agent, or blowing agent mixture, is present in the A and/or B components, or that is added at the time the foam is prepared.

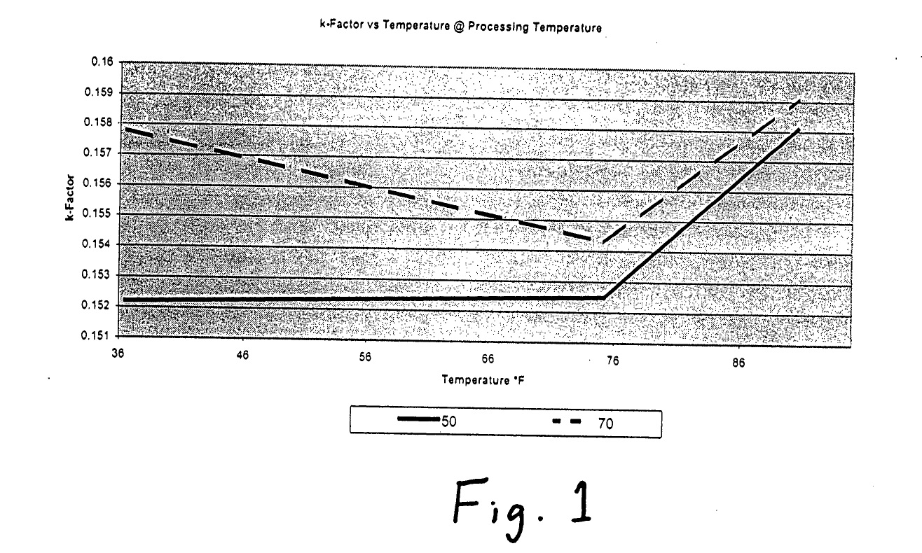

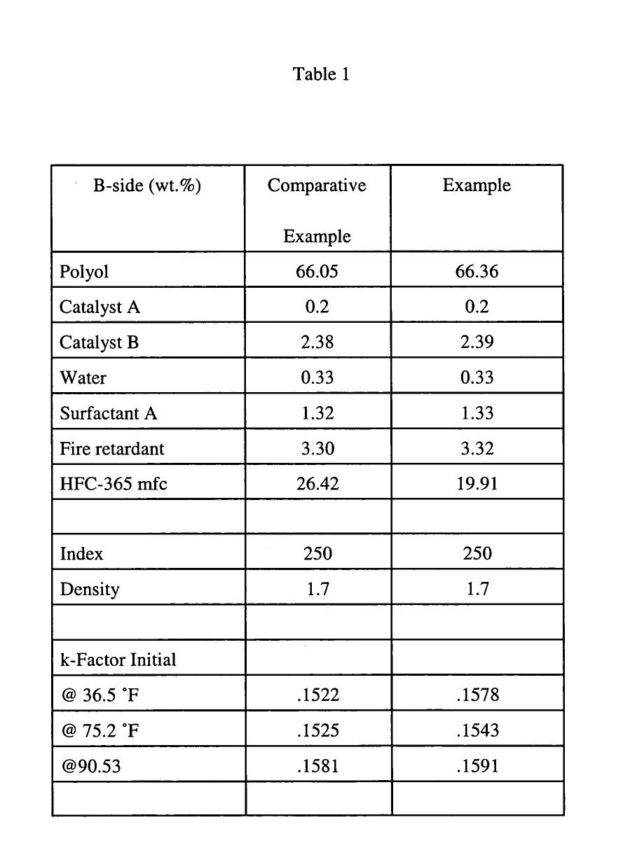

Applicants have further discovered that, according to certain embodiments, methods comprising providing a high-boiling blowing agent at or below about 76° F. to a foamable reaction mixture at any temperature, whether the reaction temperature is above or below the temperature of the blowing agent, provides foams having improved low k-factors. For example, in such embodiments, the initial reaction temperature may be from below about 36° F. to above about 90° F. as shown, for example, in FIG. 1.

According to certain embodiments, it is preferred that the blowing agent be provided to the reaction mixture at a temperature below about 65° F., more preferably at a temperature below about 60° F., even more preferably at a temperature below about 55° F., and even more preferably, at a temperature below about 50° F.

Any of the aforementioned methods for storing, cooling and providing to the reaction mixture of blowing agents can be used in the present embodiments.

According to certain preferred embodiments, the foams produced according to the present invention exhibit a k-factor of less than about 0.160, and even more preferably, less than about 0.155, and even more preferably, less than about 0.153.

### EXAMPLES

The invention is further illustrated by the following examples, in which parts or percentages are by weight unless otherwise specified. The following materials are used in the examples.

Polyol: A polyester polyol with an OH number of 240 containing a compatibilizer to aid miscibility. It is a commercially available from Stepan.

HFC-365mfc: 1,1,1,3,3-pentafluorobutane available commercially from Solvay.

Surfactant A: A polysiloxane polyether copolymer, which is commercially available from Goldschmidt.

Catalyst A: An inorganic potassium based amine, which is commercially available from Air Products.

Catalyst B: A trimerization catalyst which is commercially available from Air Products.

Two foams (“Comparative Example” and “Example”) are prepared by a general procedure commonly referred to as “handmixing”. For each blowing agent, a premix of the same polyol, surfactant, and catalysts is prepared in the same proportions displayed in Table 1. About 100 grams of each formulation is blended. The premix is blended in a 32 oz can, and stirred at about 1500 rpm with a Conn 2″ diameter ITC mixer until a homogeneous blend is achieved.

### Comparative Example

When mixing is complete, the can containing the mix is covered and placed in a refrigerator controlled at 70° F. A high boiling blowing agent is also stored in pressure bottles at 70° F. The A-component is kept in sealed containers at 70° F.

The blowing agent is added in the required amount to the premix. The contents are stirred for two minutes with a Conn 2″ ITC mixing blade turning at 1000 rpm. Following this, the mixing vessel and contents are re-weighed. If there is a weight loss, the blowing agent was added to the solution to make up any weight loss. The can is than covered and replaced in the refrigerator.

After the contents cool again to 70° F., approximately 10 minutes, the mixing vessel is removed from refrigerator and taken to the mixing station. A pre-weighted portion of A-component, isocyanurate, is added quickly to the B-component, the ingredients mixed for 10 seconds using a Conn 2″ diameter ITC mixing blade at 3000 rpm and poured into a 8″×8″×4″ cardboard cake box and allowed to rise. Cream, initiation, gel and tack free times were recorded for the individual polyurethane foam sample.

The foams thus produced are allowed to cure in the boxes at room temperature for at least 24 hours. After curing, the blocks are trimmed to a uniform size and the densities measured. Any foams that do not meet the density specification 1.7±0.1 lb/ft³ are discarded and new foams are prepared.

After ensuring that all the foams meet the density specifications, the foams are tested for k-factor according to ASTM C518. The k-factor results are listed in the first column of Table 1 and are show graphically in FIG. 1.

### Example

When mixing is complete, the can containing the mix iss covered and placed in a refrigerator controlled at 50° F. The same blowing agent that was used in the Comparative Example is stored in pressure bottles at 50° F. The same A-component as was used in the Comparative Example is kept in sealed containers at 70° F.

The pre-cooled blowing agent is added in the required amount to the premix. The contents are stirred for two minutes with a Conn 2″ ITC mixing blade turning at 1000 rpm. Following this, the mixing vessel and contents are re-weighed. If there was a weight loss, the blowing agent is added to the solution to make up any weight loss. The can is than covered and replaced in the refrigerator.

After the contents cool again to 50° F., approximately 10 minutes, the mixing vessel is removed from refrigerator and taken to the mixing station. A pre-weighted portion of A-component, isocyanurate, is added quickly to the B-component, the ingredients mixed for 10 seconds using a Conn 2″ diameter ITC mixing blade at 3000 rpm and poured into a 8″×8″×4″ cardboard cake box and allowed to rise. Cream, initiation, gel and tack free times are recorded for the individual polyurethane foam sample.

The foams are allowed to cure in the boxes at room temperature for at least 24 hours. After curing, the blocks are trimmed to a uniform size and densities measured. Any foams that do not meet the density specification 1.7±0.1 lb/ft³ are discarded and new foams are prepared.

After ensuring that all the foams meet the density specifications, the foams are tested for k-factor according to ASTM C518. The k-factor results are listed in the second column of Table 1 and are show graphically in FIG. 1.

As can be seen from Table 1 and FIG. 1, the methods of the present invention provide a dramatic, commercially significant, and unexpected decrease in the k-factor of the foam relative the foam produced in accordance with conventional techniques.

What is claimed is:

1. A method of producing a foam comprising the steps of:
(a) providing a foamable reaction mixture having an initial reaction temperature;
(b) providing a blowing agent comprising at least one high boiling flurocarbon compound at a temperature below said initial reaction temperature;
(c) introducing said reduced temperature blowing agent to the reaction mixture; and
(d) creating a foam from said reaction mixture containing said blowing agent.

2. The method of claim 1 wherein said high boiling compound has a boiling temperature of at least about 100° F.

3. The method of claim 1 wherein said blowing agent is provided at a temperature at least about 3° F. below said initial reaction temperature.

4. The method of claim 1 wherein said blowing agent is provided at a temperature at least about 10° F. below said initial reaction temperature.

5. The method of claim 4 wherein said initial reaction temperature is from about 55° F. to about 70° F.

6. The method of claim 1 wherein said initial reaction temperature is from about 55° F. to about 70° F.

7. The method of claim 6 wherein said blowing agent is provided at a temperature below about 65° F.

8. The method of claim 1 wherein said at least one high boiling flurocarbon compound comprises at least one hydrofluorocarbon compound having from about 2 to about 5 carbon atoms.

9. The method of claim 1 wherein said at least one high boiling flurocarbon compound comprises HFC-365mfc.

10. The method of claim 9 wherein said at least one high boiling flurocarbon compound consists essentially of HFC-365mfc.

11. The method of claim 1 wherein said blowing agent comprises HFC-365mfc and HFC-245fa.

12. The method of claim 1 wherein said blowing agent consists essentially of HFC-365mfc and HFC-245fa.

13. The method of claim 1 wherein said blowing agent comprises HFC-365 and pentfluoropropane.

14. The method of claim 1 wherein said at least one high boiling flurocarbon compound comprises at least one hydrofluorocarbon compound having from about 2 to about 5 carbon atoms.

15. A closed cell foam made in accordance with the method of claim 1.

16. The closed cell foam of claim 15 having a k-factor of less than about 0.160.

17. The closed cell foam of claim 15 having a k-factor of less than about 0.153.

18. The closed cell foam of claim 15 comprising a rigid foam.

19. A method of producing a foam comprising the steps of:
(a) providing a foamable reaction mixture comprising a polyisocyanate, a polyol, and catalyst, said mixture having an initial reaction temperature of no less than about 70° F.; and
(b) introducing to the reaction mixture HFC-365mfc at a temperature of no greater than about 65° F.; and
(c) forming a rigid foam having a k-factor of less than about 0.160 from said reaction mixture after said introducing step (b).

20. The method of claim 19 wherein said introducing step (b) comprises introducing a blowing agent containing said HFC-365mfc to said reaction mixture.

21. The method of claim 21 wherein said blowing agent further comprises pentfluorpropane.

22. A method of producing a foam comprising the steps of:
(a) providing a foamable reaction mixture; and
(b) introducing to the reaction mixture a blowing agent at a temperature of not greater than about 76° F.; and
(c) forming a rigid foam having a k-factor of less than about 0.160 from said reaction mixture after said introducing step (b).
